(19) United States
(12) Patent Application Publication
(10) Pub. No.: US 2010/0137670 A1
(43) Pub. Date: Jun. 3, 2010

(54) PROCESS AND APPARATUS FOR INJECTING OXYGEN INTO A REACTION GAS FLOWING THROUGH A SYNTHESIS REACTOR

(75) Inventors: Max Heinritz-Adrian, Muenster (DE); Stefan Hamel, Wenden (DE); Lothar Semrau, Essen (DE)

Correspondence Address: MARSHALL & MELHORN, LLC, FOUR SEAGATE - EIGHTH FLOOR, TOLEDO, OH, 43604, US

(73) Assignee: UHDE GMBH, DORTMUND (DE)

(21) Appl. No.: 12/312,502

(22) PCT Filed: Nov. 5, 2007
(86) PCT No.: PCT/EP2007/009551

§ 371 Date: Feb. 5, 2010

(30) Foreign Application Priority Data
Nov. 16, 2006 (DE) 10 2006 054 415.3

(51) Int. Cl. C07B 41/00; B01J 19/00

(52) U.S. Cl. 585/654; 422/220

(57) ABSTRACT

Synthesis reactor comprising an apparatus for injecting oxygen, which can be initially charged in pure form, as air, or mixed with inert gas or water vapor, into a reaction gas which can flow through the synthesis reactor which finds use, for example, in an oxydehydrogenation plant, wherein oxygen and reaction gas have different temperatures, wherein a distribution element is provided upstream of the device for accommodating a catalyst charge in flow direction of the reaction gas, said distributor element comprising a distributor body, two tube plates and a multitude of gas guide tubes for passing the reaction gas through, and the oxygen can be supplied to the chamber between the gas guide tubes, wherein at least one baffle plate is arranged orthogonally to the gas guide tubes and divides the intermediate space into at least two distributor chambers, wherein the distributor chambers are connected to one another or merge into one another fluidically through one or more orifices, at least one gas line leads into the first distributor space in flow direction, through which the oxygen can be supplied, and the lower tube plate is provided in flow direction with a multitude of orifices in the form of nozzles, bores or the like, through which the oxygen can leave the intermediate space, wherein a solids-free gas mixing zone is provided below the lower tube plate.

The invention relates to a synthesis reactor which is equipped with a device for injecting oxygen-containing gas into a reaction gas which flows through a synthesis reactor, the oxygen-containing gas to be injected and the reaction gas being of different temperatures, wherein an oxygen distribution device consisting of a distributor body with two tube sheets and a plurality of gas guide tubes for conveying the reaction gas is provided in flow direction of the reaction gas upstream of the compartment accommodating a catalyst charge and the oxygen can be supplied to the intermediate space around and between the gas guide tubes. Orthogonally to the gas guide tubes, at least one baffle plate is arranged which subdivides the intermediate space into at least two distribution chambers, the distribution chambers being interconnected via one or several openings or intertwining so to ensure the fluid passage. In addition, a gas line by which the oxygen can be supplied runs into the first distribution chamber and the lower tube sheet in direction of the flow is provided with a plurality of openings in the form of nozzles, boreholes and the like, through which the oxygen can escape from the intermediate space and pass into the solid-free gas mixing zone which is provided underneath the lower tube sheet. According to the present invention the oxygen-containing gas and the reaction gas are supplied into the mixing zone so to ensure that mixing is achieved before the gas mixture enters the catalyst charge where the intended reactions will then take place. In the ideal case, the distance between the end of the nozzle and the surface of the catalyst bed is selected such that the mixing has taken place before the reactions in the mixing zones have come to an end or have proceeded to a negligible extent.

Gas distribution systems for synthesis reactors are well-described in the art. U.S. Pat. No. 6,267,912 B1 discloses a synthesis reactor with a distribution system, where every reaction-gas conveying channel is connected to one or several feed-gas conveying channels. The suggested distribution system is very design-intensive and involves the problem to select the channel cross-sections in such a way that the required part-streams of the reaction gas and the feed gas are adjusted precisely.

Known are also systems in which the reaction gas flows through a plurality of gas guide tubes and the feed gas around these gas guide tubes in a distribution chamber and enters these gas guide tubes directly via one or several boreholes, where it is mixed. Synthesis reactors including such gas distribution devices are described in U.S. Pat. No. 5,106,590 A, DE 38 75 305 T2 or WO 02/078837 A1. All these devices involve the problem that even in the case of only slightly different opening cross-sections, fabrication inaccuracies or pressure differences of the gas guide tubes, the latter will be supplied with different amounts of feed gas. Since no cross-mixture takes place upstream of the catalyst bed, this gas flow proceeds through the catalyst bed so that the conversion rate decreases. DE 10 2004 024 957 A1 shows a similar distribution device which is placed onto or attached to the catalyst particle filling. This involves the problem that the hot gas jet entering the catalyst will burn holes into the bed if the arrangement is not done in an optimum way.

WO 03/004405 A1 and JP 2003-013072 A describe a process and a device for the production of synthesis gas by autothermal reforming (ATR). Here, an oxygen-containing gas is mixed with a reaction gas in such a way that it oxidises partially before the gas mixture reaches a downstream catalyst bed. The distribution device is designed such that the oxygen-containing gas is passed through the inner part of a nozzle and the reaction gas is supplied through an external concentric annular gap designed to ensure that a diffusion flame is formed which is as steady as possible. Inside the distribution device there is also a perforated plate which is used to generate an artificial pressure loss by which the reaction gas is to be distributed quantitatively as evenly as possible over the concentric annular gap. Hence the device suggested therein does not aim at the mere, if possible, reaction-free mixing but constitutes an overall burner facility by which partial oxidation is performed by means of numerous individual burners in steady flames.

In contrast to the present invention which in the ideal case allows mixing only but no or only a very little reaction conversion before the gas mixture enters the catalyst bed, WO 03/004405 A1 and JP 2003-013072 A describe the targeted partial oxidation of the reaction gas which is induced in such a way that an as steady flame as possible is formed at the coaxial-type nozzles. According to WO 03/004405 A1 and JP 2003-013072 A and inversely to the present device the reaction gas is conveyed inside the distribution device and the oxygen-containing gas through the axial tubes to the burners. Thus a large volume filled with oxygen is produced in flow direction upstream of the distribution device. In the present invention there is oxygen-containing gas in the confined volume of the oxygen distribution device only, which is to be preferred not least because of safety considerations.

Document WO 2007/045457 presents a mixing device which mixes oxygen and reaction gas by passing oxygen through axial tubes and distributing it radially and axially into the reaction gas by means of distribution devices fitted to the end of the axial tubes. The axial tubes extend beyond the tube sheet into the mixing zone. The reaction gas is conveyed outside of the axial tubes and fed to the mixing zone through slots or openings.

Analyses have shown that tubes which extend beyond the tube sheet create zones with disadvantageous flow conditions and recirculation flows, especially between the tube sheet and the end of the tubes. This not only affects the mixing efficiency but also prolongs the retention time of a part of the gas mixture or the individual gases such that an increased number of local reactions may be the result. In the present invention, the ends of the axial tubes are therefore provided flush with the lower tube sheet and, for the purpose of the injection, connected to the specified nozzles with the geometric arrangement characteristics of the axial tubes and the spatial arrangement of the catalyst bed, because this is required to achieve a mixture of the quality requested.

In addition, WO 2007/045457 does not provide for baffle or guide plates inside the distribution device. Consequently, if the two gases are of different temperatures, this will inevitably produce an inhomogeneous temperature distribution in the gas inside the distribution device before the gas reaches the mixing chamber. This will not only affect the equal distribution of the mass flow via the specified outlet slots but also the mixing quality after the entry into the mixing chamber which will be inhomogeneous due to the locally different temperatures and the resulting different physical properties across the reactor cross-section. In contrast to this, the present invention provides for a targeted flow configuration and retention time prolongation inside the oxygen distribution box by means of deflector plates, producing a uniform temperature of the oxygen before it is supplied through the nozzles into the mixing chamber. The uniformity of the temperature inside the box before leaving the nozzles is a precondition to ensure uniform flow through the nozzles across the total reactor cross-section and consequently uniform supply into the mixing chamber. The device allows adjustment of a uniform oxygen temperature even in the event of high differences in temperature of the reaction gas and the oxygen and large reactor cross-sections with hence large dimensions of the oxygen distribution device.

The continuing aim is to provide a synthesis reactor of unsophisticated design which allows to run a reliable process.

The aim is achieved by the synthesis reactor in accordance with the invention including a device for the injection of oxygen, the oxygen being supplied either in pure form, in air or mixed with inert gas or steam. This oxygen-containing gas can be injected into a reaction gas flowing through a synthesis reactor as, for example, used in an oxy-dehydrogenation plant, the oxygen-containing gas and the reaction gas being of different temperatures, wherein an oxygen distribution device is provided in direction of the reaction-gas flow upstream of the compartment accommodating the catalyst charge, consisting of a distributor body, two tube sheets and a plurality of gas guide tubes for the passage of the reaction gas, and the oxygen can be supplied to the intermediate space around and between the gas guide tubes, wherein
i) at least one baffle plate is arranged orthogonally to the gas guide tubes, which subdivides the intermediate space into at least two distribution chambers, the distribution chambers being interconnected via one or several openings or intertwining so to ensure the fluid passage, and
ii) at least one gas line by which the oxygen can be supplied runs into the first distribution chamber in direction of the flow, and
iii) the lower tube sheet in direction of the flow is provided with a plurality of openings in the form of nozzles, boreholes or the like, through which the oxygen can escape from the intermediate space,
iv) a solid-free gas mixing zone being provided underneath the lower tube sheet.

Depending on the respective flows, the distance between nozzles, boreholes, etc. and the surface of the catalyst charge is at best not below 40 mm, not above 250 mm, but preferably 120 mm.

In response to the continuing increase in the temperature difference between the oxygen-containing gas and the reaction gas, the synthesis reactor can be improved by installing several baffle plates. The baffle plates are at best inclined to ensure that the pressure above the boreholes or nozzles is evenly distributed in radial direction.

An improved variant provides that the boreholes or nozzles which are arranged in the lower tube sheet are inclined from the perpendicular. In the ideal case, the inclination should be in tangential direction. Thus it is avoided that the flow streams directly towards the reactor walls.

Another improvement is to provide every borehole or align the nozzles such that these are directed towards the axis of an individual gas guide tube below the outlet of that respective gas guide tube, thus ensuring that each reaction gas jet is furnished with least one O₂ jet as a direct reaction partner.

In the mixing zone underneath the lower tube sheet a plurality of small mixing spaces will form in specified normal operation. It may also be provided to direct several boreholes or nozzles towards the axis of a gas guide tube below the outlet of that respective gas guide tube.

In an advantageous embodiment, the gas guide tubes for conveying the reaction gas are arranged in concentric circles inside the reactor. The efficiency of the mixing processes in the mixing zone can be improved if the gas guide tubes are arranged to each other at an angle of 45°, 30° or 60°.

The invention also includes a process involving a synthesis reactor according to any of the before-mentioned embodiments, in which the oxygen leaves the individual nozzle at a gas velocity of at least 60 m/s, preferably at least 100 m/s and ideally at least 140 m/s.

In a preferred process variant the oxygen is completely or nearly completely mixed with the reaction gas leaving the gas guide tubes prior to entering the catalyst charge. To achieve that the desired reaction within the catalyst particle filling takes place in the best possible way, the aim is to mix the oxygen-containing gas and the reaction gas as uniformly as possible before the mixtures reaches the catalyst particle filling. If the mixing result is not ideal, this will become evident by local streaks on the surface of the catalyst particle filling, which are of a higher or lower oxygen concentration than in the case of an ideal mixture. The mixing quality can thus be expressed by the local deviations of the oxygen concentration in the gas mixture from the ideal mean mixing value of the oxygen concentration at the catalyst bed surface. A nearly complete mixing result has been obtained if, upon entry into the catalyst bed, local oxygen concentrations in the mixture of reaction gas and supplied oxygen do not drop below a minimum oxygen concentration of 60% of the average oxygen concentration in the event of an ideal mixing result. The preferred oxygen concentration should be above 80% and ideally above 90% of the average O₂ concentration.

The process may be improved in such a way that the temperature difference of the oxygen inside the oxygen distribution device when entering the gas mixing zone is below 100° C. at all nozzles. The preferred temperature difference is below 50° C. and in the ideal case below 30° C. The flow through nozzles is influenced by the operating conditions such as pressure and temperature and the dependent physical properties such as density and viscosity. In the event of a uniform input pressure, the flow through all nozzles is the more uniform the more uniform the temperature distribution of the oxygen-containing gas inside the oxygen distribution device.

The reason for an uneven distribution of the oxygen temperature inside oxygen distribution devices is that the temperature of the oxygen supplied to the distribution device and that of the reaction gas which is conveyed in the gas guide tubes of the oxygen distribution device are different for process reasons. Thus, an indirect heat exchange between oxygen and reaction gas takes place via the gas guide tubes. Since real-size reactors are designed with diameters of possibly up to several metres, high temperature differences occur at the individual nozzles due to the most varying paths of flow and the consequently most varying retention times of the oxygen from the feed points of the oxygen distribution device to the outlet nozzles. These temperature differences at the outlet nozzles, in turn, are the reason for different nozzle flow rates which, on the other hand, will lead to an uneven distribution of the oxygen across the reactor cross-section. By the design types available to date it has not been possible to achieve such an evenly distributed temperature of the oxygen-containing gas inside the oxygen distribution device.

Thus it is best to run the process by providing for a heat exchange between the supplied oxygen at the gas guide tubes and the space around the gas guide tubes to ensure that the oxygen which enters the gas mixing chamber is essentially of the same temperature as the reaction gas in that chamber.

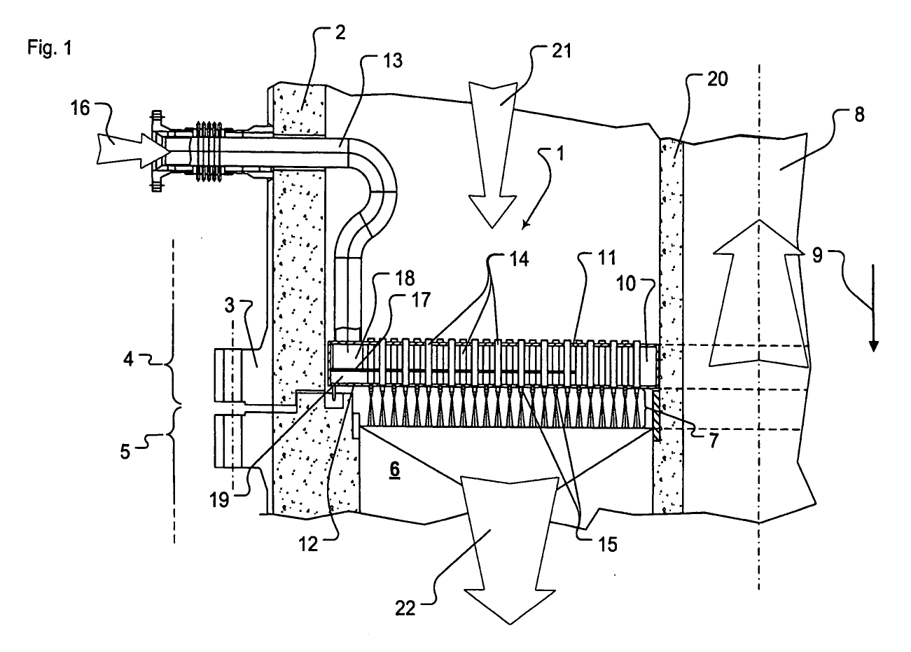

FIG. 1 shows a sectional drawing of the synthesis reactor according to the invention and the integral distribution device 1 in a specific embodiment. Distribution device 1 is provided in a synthesis reactor which is represented in part only. It shows outer wall 2 of the synthesis reactor, which is equipped with a flange 3 at the level of the support of distribution device 1, which subdivides the synthesis reactor into an upper reactor segment 4 and a lower reactor segment 5. Somewhat below distribution device 1 and in the area of lower reactor segment 5 there is a catalyst particle filling 6. The gas compartment below distribution device 1 represents mixing zone 7 which serves to mix the reaction gas and the oxygen, which then flow through catalyst particle filling 6, this being the place of the actual synthesis reaction. Downstream of catalyst particle filling 6 and at the bottom of the synthesis reactor the gas is diverted in a not represented way into central pipe 8 and leaves the synthesis reactor through an outlet opening which is also not represented, the direction of gravity being indicated by 9.

The main elements of the distribution device 1 shown in FIG. 1 are a distributor body 10 in ring form, consisting of an upper tube sheet 11 and a lower tube sheet 12 as well as several gas lines 13 routed into distributor body 10, whereas FIG. 1 shows one gas line 13 only. Distributor body 10 contains a plurality of vertical gas guide tubes 14 which allow the flow to pass through distributor body 10 by connecting the interior of the upper reactor segment 4 with mixing zone 7. Lower tube sheet 12 accommodates a plurality of nozzles 15, the number of which is identical with that of gas guide tubes 14. Furthermore, a concentric baffle plate 17 is installed in distributor body 10 in parallel to tube sheets 11 and 12 and vertically to gas guide tubes 14, which subdivides the interior of distributor body 10 into an upper distribution chamber 18 and a lower distribution chamber 19. The two chambers are connected in the area of the central pipe wall 20 to ensure the fluid passage.

In specified normal operation oxygen-containing gas is conveyed through gas line 13 in direction of the arrow 16 into the interior of distributor body 10. By baffle plate 17 the oxygen-containing gas in the upper distribution chamber 18 is routed radially into the direction of central pipe 8, to ensure a flow around gas guide tubes 14 and a heat exchange. Subsequently the oxygen-containing gas enters lower distribution chamber 19 at the end of baffle plate 17 near central pipe wall 20 which it exits through nozzles 15 leading into mixing zone 7. Here, the oxygen-containing gas is united with the reaction gas which flows in direction of the arrow 21 from upper reactor segment 4 and gas guide tubes 14 into gas mixing zone 7. The mixture of oxygen-containing gas and reaction gas flows in direction of the arrow 22 through catalyst particle filling 6, where the actual synthesis reaction takes place.

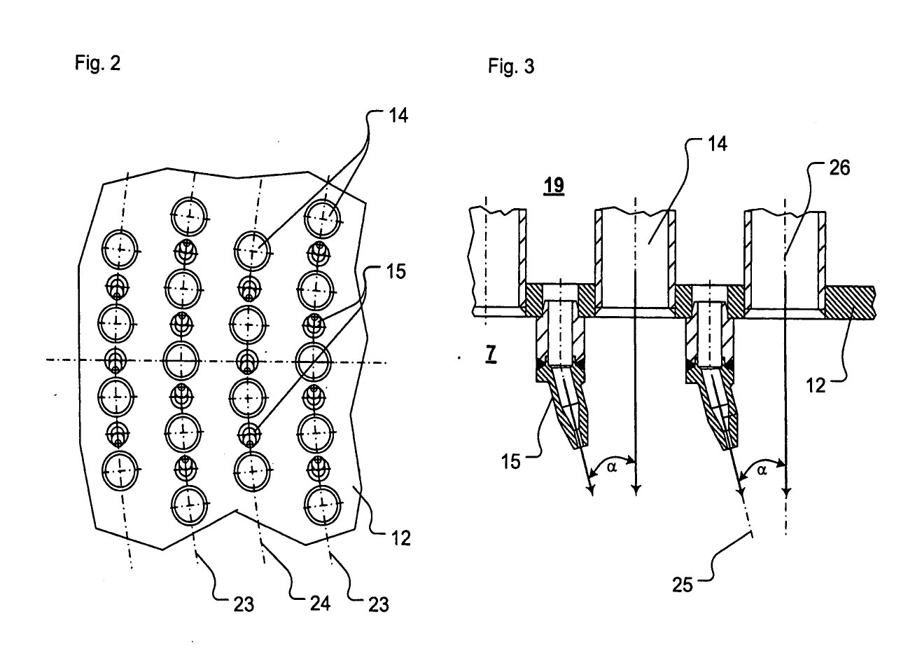

FIG. 2 shows the plan view of lower tube sheet 12 from below, of which, however, only a section is represented. It shows that gas guide tubes 14 and nozzles 15 are arranged along concentric circular paths 23 and 24. Gas guide tubes 14 and nozzles 15 are provided in alternating sequence along the circular path.

The sectional drawing according to FIG. 3 shows the same lower tube sheet 12 to illustrate the inclination of nozzles 15. The rotational axis 25 of nozzles 15 is inclined from the perpendicular at an angle α and directed towards rotational axis 26 of a directly adjacent gas guide tube 14. In this way one oxygen-containing gas jet each from lower distribution chamber 19 released at a high pulse via nozzle 15 into mixing zone 7 coincides with one reaction gas jet each entering mixing zone 7 vertically from above via a gas guide tube 14. These two gas jets unite somewhat below lower tube sheet 12 and mix before the mixture enters catalyst particle filling 6.

List of References Used
1 Distribution device
2 Outer wall
3 Flange
4 Reactor segment (upper)
5 Reactor segment (lower)
6 Catalyst particle filling
7 Mixing zone
8 Central pipe
9 Direction of gravity
10 Distributor body
11 Upper tube sheet
12 Lower tube sheet
13 Gas line
14 Gas guide tube
15 Nozzle
16 Arrow, direction of flow
17 Baffle plate
18 Distribution chamber (upper)
19 Distribution chamber (lower)
20 Wall of central pipe
21 Arrow, direction of flow
22 Arrow, direction of flow
23 Concentric circular path
24 Concentric circular path
25 Rotational axis
26 Rotational axis

1-11. (canceled)

12. A synthesis reactor including a device for injecting oxygen, which is supplied in pure form, in air or mixed with inert gas or steam, into a reaction gas which flows through the synthesis reactor as, for example, used in an oxydehydrogenation plant, the oxygen and the reaction gas being of different temperatures, wherein a distribution device is provided in direction of the reaction gas flow upstream of the compartment accommodating the catalyst charge, consisting of a distributor body, two tube sheets and a plurality of gas guide tubes for the passage of the reaction gas, and the oxygen can be supplied to the intermediate space between the gas guide tubes, wherein
at least one baffle plate is arranged orthogonally to the gas guide tubes, which subdivides the intermediate space into at least two distribution chambers, the distribution chambers being interconnected via one or several openings or intertwining so to ensure the fluid passage, and
at least one gas line by which the oxygen can be supplied runs into the first distribution chamber in direction of the flow, and
the lower tube sheet indirection of the flow is provided with a plurality of openings in the form of nozzles, boreholes or the like, through which the oxygen can escape from the intermediate space,
a solid-free gas mixing zone being provided underneath the lower tube sheet.

13. The synthesis reactor according to claim 12, wherein the distance between the boreholes or openings and the surface of the catalyst charge is not below 40 mm and not above 250 mm.

14. The synthesis reactor according to claim 12, wherein the boreholes or nozzles which are arranged in the lower tube sheet are inclined from the perpendicular.

15. The synthesis reactor according to claim 14, wherein the boreholes or nozzles are inclined in tangential direction from the perpendicular.

16. The synthesis reactor according to claim 14, wherein every borehole or nozzle is directed towards the axis of an individual gas guide tube below the outlet of that respective gas guide tube, also allowing that several boreholes or nozzles are directed to the axis of a feed tube below the outlet of that respective gas guide tube.

17. The synthesis reactor according to claim 12, wherein the gas guide tubes for conveying the reactor gas are arranged in concentric circles inside the reactor.

18. The synthesis reactor according to claim 12, wherein the gas guide tubes are arranged to each other at an angle of 45° or 30° or 60°.

19. A process involving a synthesis reactor according to claim 12, wherein the oxygen leaves the individual nozzle at a gas velocity of at least 60 m/s.

20. The process according to claim 19, wherein the oxygen is completely or nearly completely mixed with the reaction gas leaving the gas guide tubes prior to entering the catalyst charge, a nearly complete mixing result being obtained if the minimum oxygen concentration in the gas is above 60% of the average oxygen concentration.

21. The process according to claim 19, wherein the temperature of the oxygen upon entry into the gas mixing zone is the same or nearly the same at all nozzles, wherein a nearly uniform temperature is achieved if the temperature difference between the nozzles is below 100° C.

22. The process according to claim 19, wherein a heat exchange between the supplied oxygen at the gas guide tubes and the space around the gas guide tubes is effected to ensure that the oxygen which enters the gas mixing chamber is essentially of the same temperature as the reaction gas in that chamber.

23. The synthesis reactor according to claim 13, wherein the distance between the boreholes or openings and the surface of the catalyst charge is 120 mm.

24. The process involving a synthesis reactor according to claim 19, wherein the oxygen leaves the individual nozzle at a gas velocity of at least 100 m/s.

25. The process involving a synthesis reactor according to claim 24, wherein the oxygen leaves the individual nozzle at a gas velocity of at least 140 m/s.

26. The process according to claim 19, wherein the oxygen is completely or nearly completely mixed with the reaction gas leaving the gas guide tubes prior to entering the catalyst charge, a nearly complete mixing result being obtained if the minimum oxygen concentration in the gas is above 80% of the average oxygen concentration.

27. The process according to claim 26, wherein the oxygen is completely or nearly completely mixed with the reaction gas leaving the gas guide tubes prior to entering the catalyst charge, a nearly complete mixing result being obtained if the minimum oxygen concentration in the gas is above 90% of the average oxygen concentration.

28. The process according to claim 19, wherein the temperature of the oxygen upon entry into the gas mixing zone is the same or nearly the same at all nozzles, wherein a nearly uniform temperature is achieved if the temperature difference between the nozzles is below 50° C.

29. The process according to claim 19, wherein the temperature of the oxygen upon entry into the gas mixing zone is the same or nearly the same at all nozzles, wherein a nearly uniform temperature is achieved if the temperature difference between the nozzles is below 30° C.
